(19) United States
(12) Patent Application Publication
(10) Pub. No.: US 2014/0320351 A1
(43) Pub. Date: Oct. 30, 2014

(54) ANTENNA FOR MOBILE DEVICE

(71) Applicant: ACER INCORPORATED, New Taipei City (TW)

(72) Inventors: Wan-Chu Wei, New Taipei City (TW); Chih-Hua Chang, New Taipei City (TW)

(73) Assignee: ACER INCORPORATED, New Taipei City (TW)

(21) Appl. No.: 14/073,035

(22) Filed: Nov. 6, 2013

(30) Foreign Application Priority Data
Apr. 24, 2013 (TW) 102114535

(51) Int. Cl. H01Q 9/06

(52) U.S. Cl. CPC H01Q 9/06
USPC 343/700 MS

(57) ABSTRACT

An antenna having a ground plane, a radiation element, disposed adjacent the ground plane and a resonant circuit coupled between a signal and the radiation element, wherein a ground resonance is excited through the resonant circuit. The ground plane, the radiation element and the resonant circuit are arranged on a same planar surface, e.g., a dielectric substrate. In one embodiment, the ground plane defines a non-ground region in which the radiation element and resonant circuit are disposed. The resonant circuit comprises at least a capacitive element and an inductive element arranged in parallel or in series with one another. The resonant circuit may be connected to an end region of the radiation element or to a central portion thereof (or to an intermediate portion). In an exemplary embodiment, the radiation element has a length that is less than 0.1-wavelength of a central operating frequency of the antenna.

### RELATED APPLICATION DATA

This application claims priority under 35 U.S.C. §119 to Taiwan patent application, TW 102114535, filed on Apr. 24, 2013, the disclosure of which is incorporated herein by reference in its entirety.

### TECHNICAL FIELD

The present disclosure relates to mobile wireless communication devices and related antennas.

### BACKGROUND

With the development of mobile communication devices, a variety of mobile communication devices have been introduced. Today, mobile communication devices may be classified into three general types: smart phones, tablet computers, and notebook computers.

Common to each type of mobile communication device is the desire for portability. In this regard, such devices are designed to have a form factor that makes them easy to hold, transport and operate in a mobile context, e.g., away from a traditional desktop computing environment. In order to enable mobility for a communication device, wireless communication must be implemented, and such wireless communication requires a suitable antenna. Conventional antennas for such wireless applications have conformed to one the following: loop antennas, dipole antennas or slot antennas wherein the size of the antenna is selected based on a half-wavelength of the desired resonant frequency, or planar inverted-F antennas (PIFA), monopole antennas or open-slot antennas wherein the size of the antenna is selected based on a quarter-wavelength of the desired resonant frequency. However, even at half- or quarter-wavelength antenna sizes, such antennas cannot be easily accommodated inside mobile devices with the desired form factors.

### SUMMARY

Embodiments of the present invention are directed to an antenna having a ground plane, a radiation element, disposed adjacent the ground plane, and a resonant circuit, coupled between a signal and the radiation element, wherein a ground resonance is excited through the resonant circuit. Additionally, the ground plane, the radiation element and the resonant circuit are arranged on a same planar surface, wherein the planar surface is the surface of dielectric substrate. In one embodiment, the ground plane defines a non-ground region in which the radiation element and resonant circuit are disposed. The resonant circuit comprises at least a capacitive element and an inductive element arranged in parallel or in series with one another. The resonant circuit may be connected to an end region of the radiation element or to a central portion thereof (or to an intermediate portion). In an exemplary embodiment, the radiation element has a length that is less than 0.1-wavelength of a central operating frequency of the antenna.

### BRIEF DESCRIPTION OF THE DRAWINGS

FIG. 1 depicts an antenna for a mobile communication device according to an embodiment of the invention;

FIG. 2 depicts an antenna for a mobile communication device according to another embodiment of the invention;

FIG. 3 is a plot that illustrates return loss of an antenna for a mobile communication device according to an embodiment of the invention;

FIG. 4 depicts an antenna for a mobile communication device according to another embodiment of the invention;

FIG. 5 depicts an antenna for a mobile communication device according to another embodiment of the invention;

FIG. 6 depicts an antenna for a mobile communication device according to another embodiment of the invention;

FIG. 7 depicts an antenna for a mobile communication device according to another embodiment of the invention; and

FIG. 8 depicts an antenna for a mobile communication device according to another embodiment of the invention.

### DESCRIPTION OF EXAMPLE EMBODIMENTS

The present inventive concept is best described through certain embodiments thereof, which are described in detail herein with reference to the accompanying drawings, wherein like reference numerals refer to like features throughout. It is to be understood that the term invention, when used herein, is intended to connote the inventive concept underlying the embodiments described below and not merely the embodiments themselves. It is to be understood further that the general inventive concept is not limited to the illustrative embodiments described below and the following descriptions should be read in such light.

Additionally, the word exemplary is used herein to mean, “serving as an example, instance or illustration.” Any embodiment of construction, process, design, technique, etc., designated herein as exemplary is not necessarily to be construed as preferred or advantageous over other such embodiments.

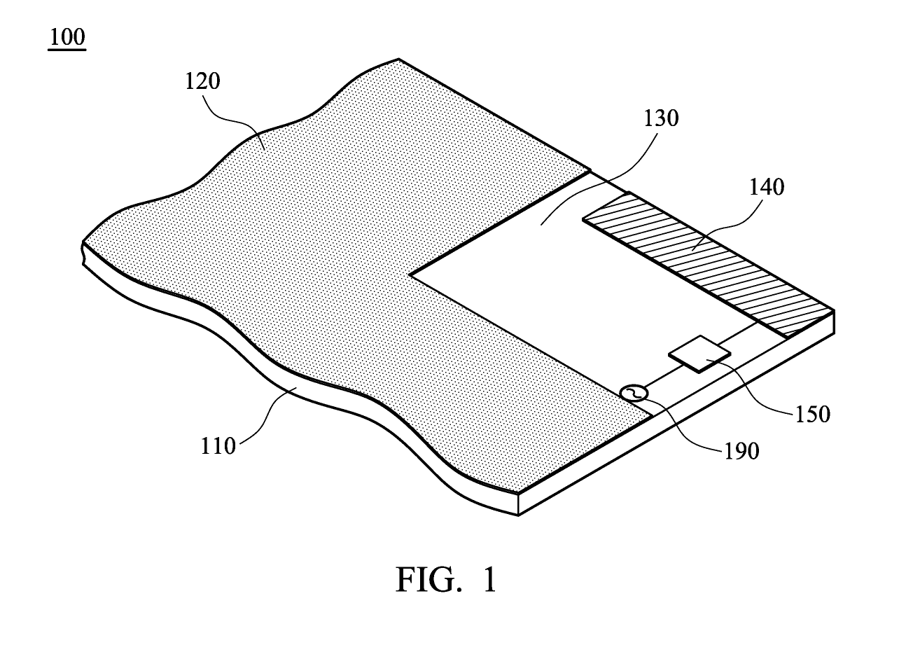

FIG. 1 depicts an antenna for a mobile communication device 100 according to an embodiment of the invention. The mobile communication device 100 could be a smart phone, tablet computer or notebook computer. As shown, the mobile communication device 100 includes a dielectric substrate 110, a ground plane 120, a radiation element 140 and a resonant circuit 150. The dielectric substrate 110 can be a system circuit board or FR4 substrate. The ground plane 120 and the radiation element 140 may be realized using metal, such as copper, silver or aluminum. The mobile communication device 100 may contain additional elements, such as a processor, a touch panel, a camera module, a loud speaker, a battery and a back cover, etc., which, for clarity, are not shown.

The ground plane 120 is disposed on the dielectric substrate 110. The dielectric substrate 110 further has a non-ground region 130. As shown, the radiation element 140 and the resonant circuit 150 are both disposed inside the non-ground region 130. In this case, the radiation element 140 is substantially “I-shaped.” However, those skilled in the art will appreciate that the radiation element 140 can also be generally, among others, L-shaped, J-shaped, U-shaped or S-shaped, some of which are described with respect to other exemplary embodiments disclosed herein. The resonant circuit 150 includes at least one capacitive element and at least one inductive element. The radiation element 140, the resonant circuit 150 and the ground plane 120 form the antenna structure, which is manifested as a generally planar structure. To excite the antenna, a signal 190 is coupled to the radiation element 140 via the resonant circuit 150. Signal 190 may be supplied from above, or may be supplied from underneath the dielectric substrate 110 through, e.g., a via. Thus, as shown, the resonant circuit 150 is coupled between the signal 190 and the radiation element 140. In this configuration, a ground resonance is excited through the resonant circuit 150.

In accordance with exemplary embodiments described herein, the capacitive element and the inductive element of the resonant circuit 150 can be configured to provide parallel-resonance or serial-resonance. That is, the capacitive element and the inductive element can be arranged in parallel with each other, or in series with each other. By choosing appropriate values for the capacitive element and the inductive element, the resonant circuit 150 can produce an “anti-resonance,” whereby, as noted above, the ground resonance is effectively excited through the resonant circuit 150 in order to cover a demanded bandwidth. That is, the resonant circuit 150 is provided to compensate for a shorter length antenna such that the antenna size (the size of the radiation element 140) for the mobile communication device 100 can be reduced and more easily incorporated into the desired form factor.

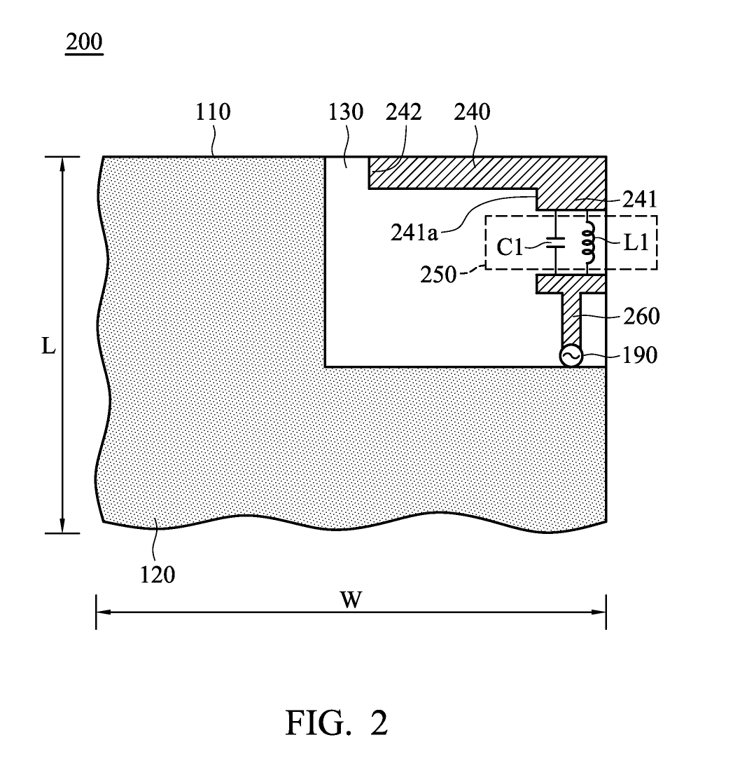

FIG. 2 depicts an antenna for a mobile communication device 200 according to a particular embodiment of the invention. Specifically, the size of the several elements and associated parameters for this embodiment are described below. The dielectric substrate 110 is an FR4 substrate. The thickness thereof is 0.8 mm and the dielectric constant is 4.4. The length of the ground plane 120 is 130 mm, and the width thereof is 70 mm. The dimensions of length (L) and width (W) and their relative orientation are depicted in FIG. 2. The length of the non-ground area 130 is 18 mm and the width is 6 mm. The length of the radiation element 240 is 13 mm and the width is 2 mm (at least along most of its length). As shown, the radiation element has a first end 241 and a second end 242. The first end 241 may include an extension 241a that extends the width of the radiation element 240 and that facilitates connection with resonant circuit 250. In such a configuration, the radiation element 240 may be considered to be substantially J-shaped.

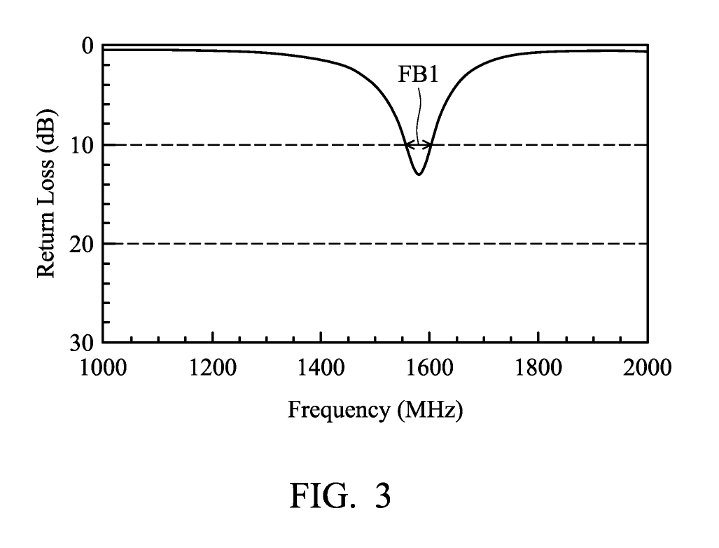

In the embodiment depicted in FIG. 2, the length of the resonant circuit 250 is 4 mm and the width is 2 mm. The value of the capacitive element C1 is about 0.8 pF. The value of inductive element L1 is about 5.6 nH. As shown, C1 and L1 are arranged in parallel. A connection element 260 (e.g., T-shaped and made from the same material as the ground plane 120) may be provided to facilitate connection of signal 190 to the resonant circuit 250. As a result of the resonant circuit 250, the length of the radiation element 240 can be less than 0.1-wavelength of the central frequency of an operation band (discussed in connection with FIG. 3 below). More specifically, the radiation element 240 may have a size on the order of 0.07-wavelength of the central frequency of an operation band. Hence, in comparison to conventional antennas that are designed having a length of even 0.25-wavelength, embodiments of the present invention can be more easily incorporated into compact mobile devices.

FIG. 3 is a plot that illustrates return loss of an antenna of a mobile communication device according to the embodiment depicted in FIG. 2. More specifically, the mobile communication device 200 as describe above excites an operation band FB1, where the bandwidth of FB1 is from 1,565 MHz to 1,585 MHz, which covers the GPS (Global Positioning System) band. As can be seen from the plot, the antenna achieves resonance at FB1 despite having such a relatively small radiation element.

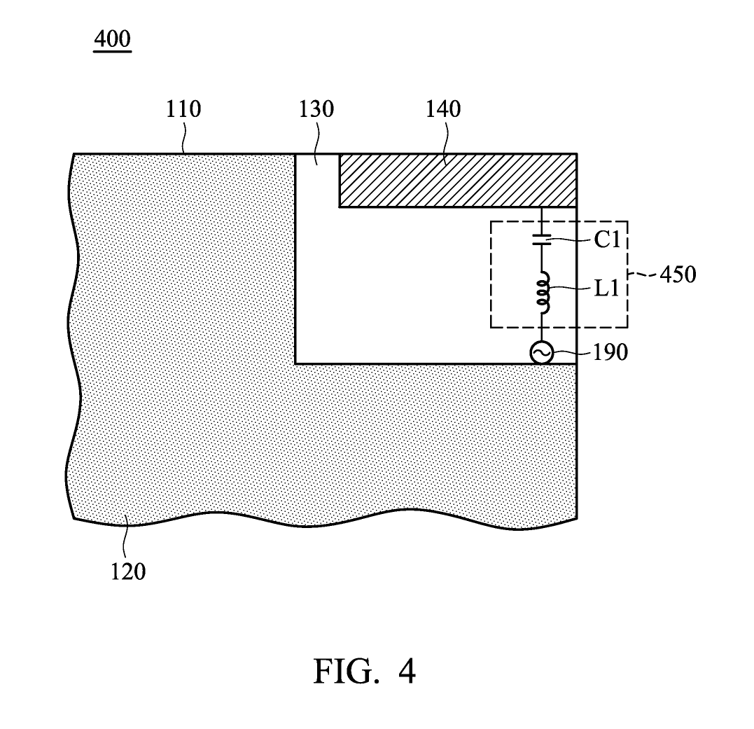

FIG. 4 depicts an antenna for a mobile communication device 400 according to another embodiment of the invention. As can be seen, mobile communication device 400 of FIG. 4 is similar to mobile communication device 100 shown in FIG. 1, including, e.g., an I-shaped radiation element 140. However, in FIG. 4, a resonant circuit 450 is configured in a serial arrangement. That is, C1 ad L1 are arranged to in series with one another.

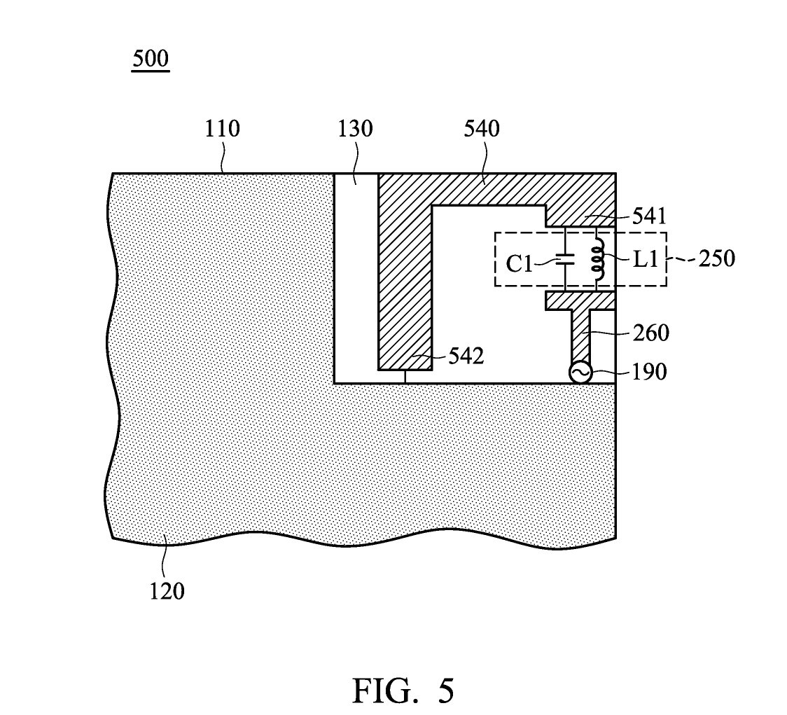

FIG. 5 depicts an antenna for a mobile communication device 500 according to yet another embodiment of the invention. The embodiment shown in FIG. 5 is similar to that shown in FIG. 2, however, in FIG. 5, while a radiation element 540 has one portion that is substantially J-shaped, the overall radiation element 540 is substantially L-shaped. More specifically, the radiation element 540 has two ends, one end 541 and another end 542. End 541 is coupled to the resonant circuit 250 and end 542 is coupled to the ground plane 120 Like the embodiment of FIG. 2, the resonant circuit 250 is configured with C1 and L1 in parallel with one another.

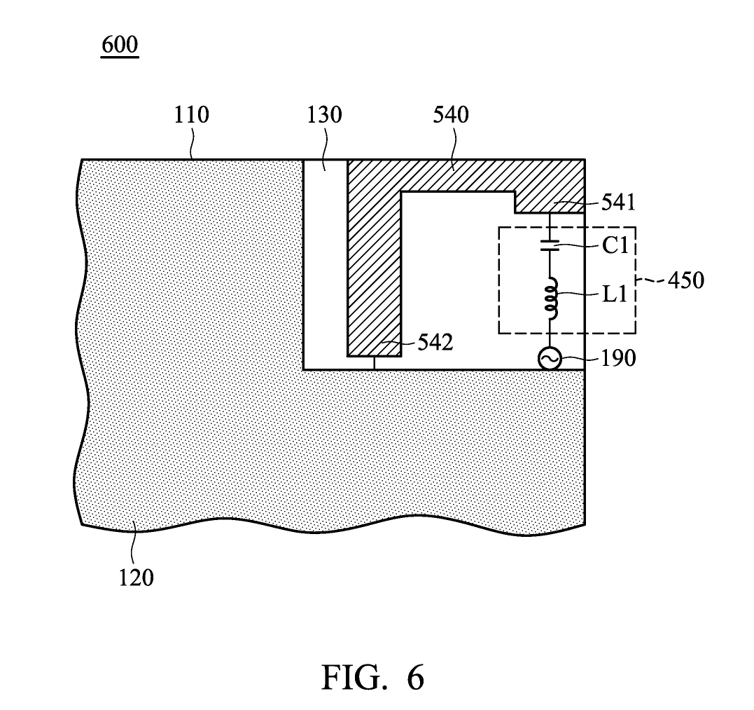

FIG. 6 depicts an antenna for a mobile communication device 600 according to still another embodiment of the invention. The embodiment shown in FIG. 6 is similar to the embodiment shown in FIG. 5, except that in the embodiment of FIG. 6, a resonant circuit 450 is configured with C1 and L1 in series with one another. As a result of the physically longer implementation of the series-connected C1 and L1 components, the connector element 260 disposed between the resonant circuit and signal 190 in FIG. 5 may be eliminated. However, those skilled in the art will appreciate that where a connector element might be useful between the resonant circuit 450 and signal 190, such an element may be employed.

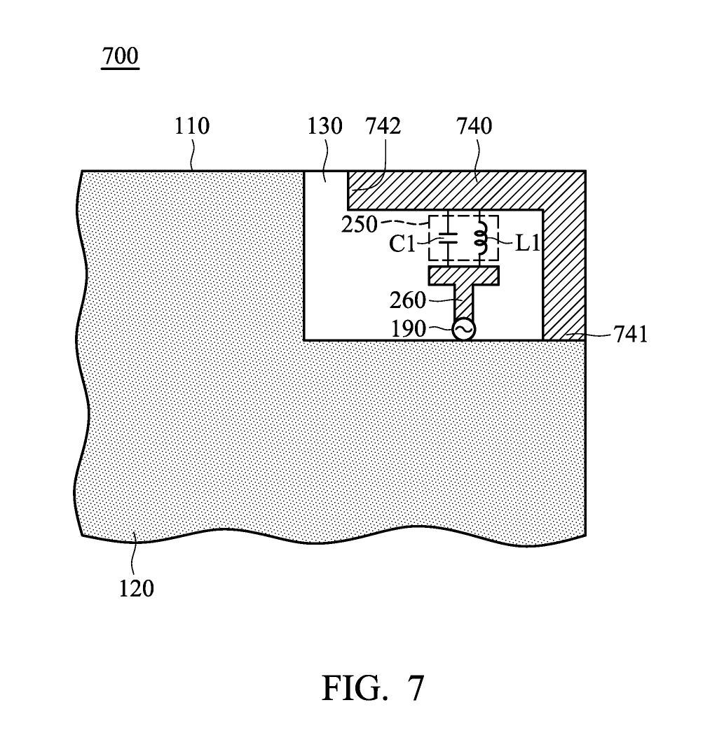

FIG. 7 depicts an antenna for a mobile communication device 700 according to another embodiment of the invention. In the embodiment shown in FIG. 7, radiation element 740 is substantially L-shaped and has two ends. One end 741 is coupled to the ground plane 120, and the other end 742 is an open-end. Furthermore, in this embodiment, the resonant circuit 250 is coupled to a central portion of the radiation element 740. Connection element 260 is disposed between signal 190 and the resonant circuit 250 (in this case configured with C1 and L1 in parallel).

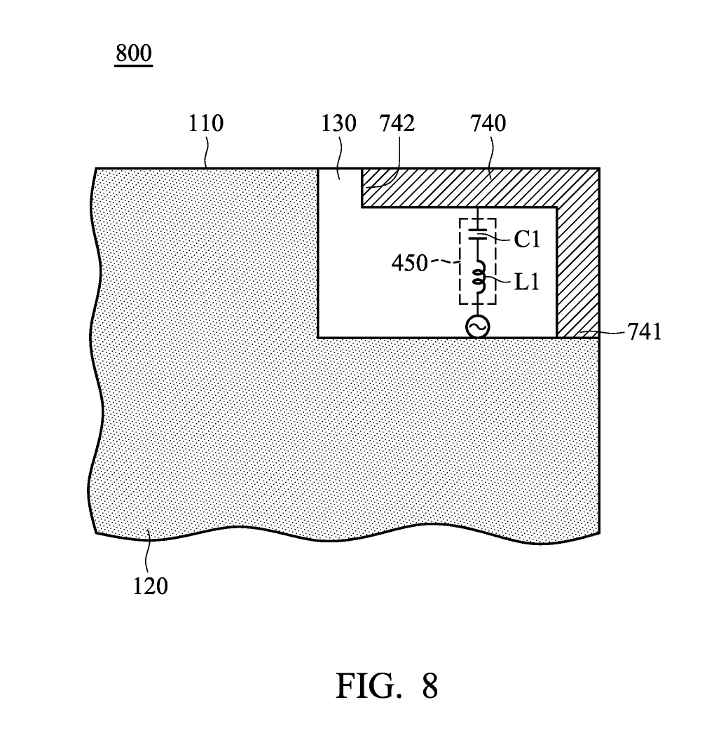

FIG. 8 depicts an antenna for a mobile communication device 800 according to another embodiment of the invention. The embodiment shown in FIG. 8 is substantially similar to the embodiment shown in FIG. 7, except the resonant circuit 450 is configured with C1 and L1 in series with one another. Those skilled in the art will appreciate that the resonant circuit may also be connected to an intermediate portion of the radiation element (i.e., not necessarily at one end or at a central portion, but at some intermediate point).

Thus, those skilled in the art will appreciate that the antenna described herein is particularly suitable for incorporation into mobile communication devices, especially those mobile communication devices having small form factors. In one embodiment, the antenna includes a ground plane, a radiation element, disposed adjacent the ground plane, and a resonant circuit coupled between a signal and the radiation element, wherein a ground resonance is excited through the resonant circuit. The ground plane, the radiation element and the resonant circuit may be arranged on a same planar surface, such as the planar surface of a dielectric substrate.

In a particular embodiment, the ground plane defines a non-ground region of planar surface and the radiation element and the resonant circuit are disposed in the non-ground region.

The radiation element itself may be I-shaped, J-shaped or L-shaped. The resonant circuit may include a capacitive element and an inductive element arranged in series with one another, or in parallel with each other.

The resonant circuit may be coupled to an end portion of the radiation element, or to a central portion of the radiation element. The radiation element may be disconnected or connected to the ground plane.

In a specific implementation, the ground plane, radiation element and resonant circuit are optimized for GPS frequencies, wherein a length of the radiation element is less than 0.1-wavelength of a central operating frequency of the antenna.

In another embodiment, a mobile communication device comprises a substrate, a ground plane disposed on the substrate, the ground plane defining, and at least partially surrounding, a non-ground region on the substrate, a radiation element disposed on the substrate and in the non-ground region, and a resonant circuit, disposed on the substrate and in the non-ground region, wherein the resonant circuit is coupled between a signal and the radiation element, and a ground resonance is excited through the resonant circuit.

The descriptions above are intended to illustrate possible implementations of the present inventive concept and are not restrictive. Many variations, modifications and alternatives will become apparent to the skilled artisan upon review of this disclosure. For example, components equivalent to those shown and described may be substituted therefore, elements and methods individually described may be combined, and elements described as discrete may be distributed across many components. The scope of the invention should therefore be determined not with reference to the description above, but with reference to the appended claims, along with their full range of equivalents.

What is claimed is:

1. An antenna, comprising:
a ground plane;
a radiation element, disposed adjacent the ground plane; and
a resonant circuit, coupled between a signal and the radiation element, wherein a ground resonance is excited through the resonant circuit.

2. The antenna of claim 1, wherein the ground plane, the radiation element and the resonant circuit are arranged on a same planar surface, and the planar surface is the surface of a dielectric substrate.

3. The antenna of claim 1, wherein the ground plane defines a non-ground region of the planar surface.

4. The antenna of claim 3, wherein the radiation element and the resonant circuit are disposed in the non-ground region.

5. The antenna of claim 1, wherein the radiation element is at least one of I-shaped, J-shaped or L-shaped.

6. The antenna of claim 1, wherein the resonant circuit comprises a capacitive element and an inductive element arranged in series with one another.

7. The antenna of claim 1, wherein the resonant circuit comprises a capacitive element and an inductive element arranged in parallel with one another.

8. The antenna of claim 1, wherein the resonant circuit is coupled to an end portion of the radiation element.

9. The antenna of claim 1, wherein the resonant circuit is coupled to a central portion of the radiation element.

10. The antenna of claim 1, wherein one end of the radiation element is coupled to the ground plane.

11. The antenna of claim 1, wherein the ground plane, radiation element, and resonant circuit are optimized for global positioning satellite (GPS) frequencies.

12. The antenna of claim 1, wherein a length of the radiation element is less than 0.1-wavelength of a central operating frequency of the antenna.

13. A mobile communication device, comprising:
a substrate;
a ground plane, disposed on the substrate, the ground plane defining, and at least partially surrounding, a non-ground region on the substrate;
a radiation element, disposed on the substrate and in the non-ground region; and
a resonant circuit, disposed on the substrate and in the non-ground region, wherein the resonant circuit is coupled between a signal and the radiation element, and a ground resonance is excited through the resonant circuit.

14. The mobile communication device of claim 13, wherein the radiation element is at least one of I-shaped, J-shaped or L-shaped.

15. The mobile communication device of claim 13, wherein the resonant circuit comprises a capacitive element and an inductive element arranged in series with one another or arranged in parallel with one another.

16. The mobile communication device of claim 13, wherein the resonant circuit is coupled to an end portion of the radiation element.

17. The mobile communication device of claim 13, wherein the resonant circuit is coupled to a central portion of the radiation element.

18. The mobile communication device of claim 13, wherein one end of the radiation element is coupled to the ground plane.

19. The mobile communication device of claim 13, wherein the ground plane, radiation element, and resonant circuit are optimized for global positioning satellite (GPS) frequencies.

20. The mobile communication device of claim 13, wherein a length of the radiation element is less than 0.1-wavelength of a central operating frequency of the antenna.
